(19) United States
(12) Patent Application Publication
(10) Pub. No.: US 2013/0148717 A1
(43) Pub. Date: Jun. 13, 2013

(54) VIDEO PROCESSING SYSTEM AND METHOD FOR PARALLEL PROCESSING OF VIDEO DATA

(71) Applicants: Yehuda Yitschak, Magen Shaul (IL); Yaniv Klein, Netanya (IL); Moshe Nakash, Or Yehuda (IL); Erez Steinberg, Tel Aviv (IL)

(72) Inventors: Yehuda Yitschak, Magen Shaul (IL); Yaniv Klein, Netanya (IL); Moshe Nakash, Or Yehuda (IL); Erez Steinberg, Tel Aviv (IL)

(73) Assignee: Freescale Semiconductor, Inc., Austin, TX (US)

(21) Appl. No.: 13/818,480

(22) PCT Filed: Aug. 26, 2010
(86) PCT No.: PCT/IB10/53843

§ 371 Date: Feb. 22, 2013

(51) Int. Cl. H04N 7/26

(52) U.S. Cl. CPC H04N 19/00521
USPC 375/240.01

(57) ABSTRACT

The invention pertains to a video processing system for video processing, the video processing system being arranged to assign tasks to least two parallel processing units capable of parallel processing of tasks. The video processing system is further arranged to control at least one storage device to store input video data to be processed, processed video data and a task list of video processing tasks. The video processing system is arranged to provide and/or process video data having a hierarchical enhancement structure comprising at least one basic layer and one or more enhancement layers dependent on the basic layer and/or at least one of the other enhancement layers. It is further arranged to assign at least one task of the task list to one of the parallel processing units; and to update, after the parallel processing unit has processed a task, the task list with information regarding tasks related to at least one enhancement layer dependent on the processed task. The invention also pertains to a corresponding method for parallel processing of video data.

### FIELD OF THE INVENTION

This invention relates to a video processing system and a method for parallel processing of video data.

### BACKGROUND OF THE INVENTION

Modern digital video applications use more and more processing power for video processing, e.g. encoding and/or decoding. In particular, recent video coding standards such as H.264 or MPEG-4 provide high-quality video data, but require a significant amount of computational resources. This is particularly true for real-time encoding and/or decoding.

On the other hand, in modern computing technology there exists a trend of providing hardware capable of parallel processing of tasks, e.g. by being able to process multiple threads, using hyper-threading technology and/or multiple cores of a computing chip or multiple processors. However, providing efficient mechanisms to parallelize video encoding and/or decoding requires new approaches and computational techniques.

The use of multi-threading in a H.264 encoder is e.g. described in “Efficient Multithreading Implementation of H.264 Encoder on Intel Hyper-Threading Architectures” by Steven Ge, Xinmin Tian and Yen-Kuang Chen, ICIS-PCM 2003, December 15-18 2003, Singapore.

### SUMMARY OF THE INVENTION

The present invention refers to a video processing system and a method for parallel processing of video data according to the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 shows a flow diagram of a method to parallelize video processing.

FIG. 2 schematically shows task dependencies for a frame.

FIG. 3 shows a block diagram of an exemple of an embodiment of a a video processing system using multiple parallel processing units.

### DETAILED DESCRIPTION OF THE PREFERRED EMBODIMENTS

Because the illustrated embodiments of the present invention may for the most part be implemented using computing or electronic components, circuits and software known to those skilled in the art, details will not be explained in any greater extent than that considered necessary for the understanding and appreciation of the underlying concepts of the present invention and in order not to obfuscate or distract from the teachings of the present invention.

In the context of the specification, the term “video processing” may in particular refer to encoding and/or decoding and/or compression, in particular entropy coding, and/or decompression and/or deblocking of video data. Encoding or decoding may include a plurality of different steps, in particular compressing, decompressing and/or deblocking, etc. Video processing, in particular encoding, may be considered to provide processed video data having a specific structure, which may be defined by the video standard used for video processing or encoding.

An encoder for video data may be considered to be a device or program for encoding video data. A decoder may be considered to be program or device for decoding video data. An encoder may be arranged to encode video data provided in a given source format into data encoded according to a given video coding standard. The video standard may for example be H.264/AVC, H.264/SVC, MPEG-4 or H.263. A decoder may decode video data from a given format into any kind of video format, in particular into a displayable and/or pixel format. Source data or input video data for an encoder may comprise raw pixel data or video data in any kind of format. It is feasible that an encoder and/or decoder is utilized to transcode video data from one video data standard into another video standard, e.g. from MPEG-4 to H.264.

Video data usually comprises a sequence or series of pictures or images arranged in a certain order, which may determined according to display timing. For encoding and/or decoding, video data may be arranged in a sequence of frames to be encoded and/or decoded. The order of frames for encoding/decoding may be different from a display order. For example, in the context of H.264, it is feasible to encode frames in an order depending on the importance for the encoding process, which differs from the order they are to be displayed in.

A frame may be any kind of frame. In particular, a frame may be one of an I-frame, B-frame or P-frame. An I-frame (intra-mode frame) may be a frame encoded/decoded without being dependent on other frames. A P-frame (predicted or predictive frame) may be encoded/decoded dependent on previously encoded/decoded frames, which may be I-frames or P-frames. A B-frame (bi-directional predicted frame) may be dependent on both previous and future frames. Depending on the video standard used, there may be additional frame types, e.g. SI-frames (Switching I-frames) or SP-frames (Switching P-frames).

For modern video standards, in particular H.264 or MPEG-4, it is possible to utilize hierarchical enhancement layers or structures to provide scalability e.g. of the temporal or spatial resolution of a video. A hierarchical enhancement structure or scalable video structure may be based on a layered representation with multiple dependencies. The hierarchical enhancement structure may be defined according to a given video standard, e.g. H.264/SVC or MPEG-4/SVC. Scalable video coding allows adapting to application requirements, e.g. processing capabilities of an encoder/decoder or limitations of a display for a video. Video data, e.g. a video bit stream, may be considered to be scalable when it is possible to form a sub-stream by removing video data and the sub-stream forms another valid video bit stream representing the original video at lower quality and/or resolution. Generally, an enhancement structure may comprise a basic layer and one or more enhancement layers dependent on the basic layer and/or at least one enhancement layer for video processing. Each layer may comprise one or more frames.

It may be feasible to provide a temporal enhancement structure. A temporal basic layer may comprise a given number of frames representing different times of video display. A temporal enhancement layer may comprise additional frames to be inserted between the frames of the temporal basic layer. Thus, by considering the temporal basic layer in combination with the temporal enhancement layer, the total number of frames to be displayed in a given time increases, improving the temporal resolution, while the temporal basic layer still provides sufficient video data for display. More than one temporal enhancement layer may be provided. It is feasible that a temporal enhancement layer depends on a basic layer and/or on one or more lower level temporal enhancement layers for video processing. A frame of a temporal enhancement layer may depend on one or more frames of the temporal basic layer and/or one or more frames of lower temporal enhancement layers to be processed. The arrangement of temporal layers and/or the temporal enhancement structure may be dependent on a video standard being used for video processing, e.g. encoding/decoding. It is feasible to use B-frames and/or P-frames for temporal enhancement layers. A hierarchical structure may evolve from the dependencies of the temporal enhancement layers, with the temporal basic layer being at the lowest level, and the temporal enhancement layers arranged such that a temporal enhancement layer of a higher level depends at most on layers of a lower level for video processing, in particular encoding/decoding.

A spatial enhancement structure comprising at least a spatial basic layer and at least one spatial enhancement layer may be considered. The basic spatial layer may comprise a frame or frames at a low resolution. It may be considered to downsample input video data to achieve a desired resolution or resolutions for a spatial basic layer and/or one or more spatial enhancement layers. It may be envisioned that the spatial basic layer corresponds to the lowest spatial resolution, e.g. a resolution of 720p. An enhancement layer may contain video data of a higher resolution. The enhancement layer and/or frames of the enhancement layer may contain data enabling to provide video data having the resolution of the enhancement layer when combined with data of the basic layer. It may be considered that the spatial enhancement layer depends on the spatial basic layer for video processing, e.g. it is feasible that a frame of the enhancement layer may only be processed if a corresponding frame of the basic layer has been processed. A hierarchical enhancement structure may comprise at its lowest level the spatial basic layer and one or more spatial enhancement layers of increasing spatial resolution corresponding to higher hierarchical levels. It may be envisioned that a spatial enhancement layer of a given level depends on one or more layers below it, but may be independent of higher level layers, if such are present. It may be feasible to use a spatial basic layer having a resolution of 720p and a spatial enhancement layer with a resolution of 1080p. For example, in the context of H.264/SVC a spatial basic layer may have a resolution of 720p (representing a resolution of 1280×720 pixels) and a first spatial enhancement layer may provide information enabling a higher resolution of 1080p (usually referring to a resolution of 1920×1080 pixels). The highest level of the spatial enhancement structure may have the resolution of an original picture or video data. The ratio between resolutions of different layers may be arbitrarily chosen, if the video standard utilized permits it.

A quality enhancement structure may be provided in which multiple layers provide increasingly higher image quality, e.g. by reducing a Signal-to-Noise Ratio when combining layers of the quality enhancement structure.

It may be feasible to provide only one enhancement structure or to combine different enhancement approaches. For example, the H.264/SVC standard allows scalable video processing utilizing temporal, spatial and quality layering.

A frame may comprise a given number of macro-blocks. A macro-block may correspond to a given number and/or arrangement of pixels which may be defined by a video standard. For example, in the H.264 standard, a macro-block may comprise 16×16 pixels. A macro-block may be used as a basic unit for representing image or picture data of a frame, in particular for encoding and/or decoding.

It is feasible to divide a frame into slices. Each slice may comprise a number of macro-blocks. It may be considered that a given frame may be divided into any suitable number of slices depending upon the video standard used for encoding/decoding. Slices of different sizes may be defined for a single frame. Slices of a frame may have any shape and may comprise disconnected regions of a frame. A slice may be considered to be a self-contained encoding unit which may be independent of other slices in the same frame in respect to video processing, in particular encoding and/or decoding. Slices may be characterized similarly to frames, e.g. as I-slices, B-slices or P-slices.

A layer may be considered as a subunit of a larger structure of video data, e.g. a video stream. A group of pictures comprising one or more frames may be considered as a subunit of a layer. Frames may be considered as subunits of layers and/or groups of pictures. A slice may be seen as subunit of a frame, as well as a subunit of the corresponding group of pictures and layer. A macro-block may be considered a subunit of a corresponding slice, frame, group of pictures and/or layer.

A first video data structure, e.g. a layer, frame, slice or macro-block may be considered to be dependent on a second video data structure if for video processing of the first video data structure the second video data structure needs to be processed before. The type of the video data structure the first video data structure depends on does not have to be the same as the type of the first video data structure, but it may. For example, a frame may be dependent on a slice or a macro-block. A data structure comprising subunits, e.g. a layer comprising frames, slices and macro-blocks, may be considered to be dependent on a second video data structure if at least one of the subunits of the first video data structure is dependent on the second video data structure and/or one of its subunits. A dependency may be direct or indirect. For example, if a third video data structure has to be processed to process the second video structure, and the second video data structure has to be processed to process the first video data structure, the first video data structure may be considered to be dependent on the second and the third video data structures. The type of video processing that has to be performed on a second video data structure before a first video data structure dependent on it may be processed does not have to be the same as the type of video processing to be performed on the first video data structure, but it may be.

It may be considered to parallelize video processing. A processing unit may be a thread, a hyper-thread, a core of a multi-core processor or a processor arranged to process video data. A processing unit may be arranged to perform video processing in parallel to another processing unit, which may thread, a hyper-thread, a core of a multi-core processor or a processor. A master processing unit may be arranged to control parallel processing by subordinate processing units.

For efficient parallelizing, it may be considered to take into account dependencies between frames or slices to be encoded and/or decoded. In the case of an encoder, the dependencies may be determined and/or defined by the encoder. The encoder may take into account requirements of a video standard according to which encoding is performed. In the case of a decoder, information regarding dependencies may be included in encoded frames provided for decoding. It may be considered to adapt a decoder to determine such dependencies for parallelizing a decoding process depending on information included in video data encoded in a given format and/or requirements of the video standard used for encoding/decoding.

An access unit may refer to frame data relating to the same point of time in a video sequence or stream. An access unit may comprise data in multiple layers, in particular a basic layer and a plurality of related enhancement layers.

A video processing system may be arranged to assign tasks to at least two parallel processing units capable of parallel processing of tasks. The video processing system may be arranged to control at least one storage device to store input video data to be processed, processed video data and a task list of video processing tasks. The video processing system may be arranged to provide and/or process video data having a hierarchical enhancement structure comprising at least one basic layer and one or more enhancement layers dependent on the basic layer and/or at least one of the other enhancement layers. The system may be arranged to assign at least one task of the task list to one of the parallel processing units. It is feasible that the system is arranged to update, after the parallel processing unit has processed a task, the task list with information regarding tasks dependent on the processed task and related to at least one enhancement layer. A task may be considered to be related to a layer if it identifies a type of video processing to be performed on the layer and/or a subunit of this layer. It may be considered to provide a master processing unit distributing or assigning tasks based on the task list and/or receiving information from subordinate processing units. One or more parallel processing units may have access to the task list. The task list may be stored in shared memory. It is feasible that parallel processing units access the task list to accept tasks on the task list for themselves, thereby assigning a task for themselves. A parallel processing unit may access the task list for updating it directly. It may be envisioned that the task list is updated by a master processing unit based on information provided by a parallel processing unit. A task may identify video data to be processed and the video processing to be performed. It may be envisioned that a task being processed by a processing unit is being updated during processing, e.g. by increasing the range of video data to be processed. Task updating may be performed by a master processing unit updating the task for a subordinate processing unit. A task may identify subtasks corresponding to processing of subunits of data of the task. A task may be represented by a suitable memory structure. A task list may represent any number of tasks. In particular, it may represent a single task. A task list may be stored in a storage device, e.g. memory like RAM, private memory of a processing core or cache memory. A task list may be distributed over disconnected memory ranges. It may be considered that the parallel processing units comprise at least one thread and/or at least one hyper-thread and/or at least one core of a multi-core processor and/or at least one processor. The video processing system may comprise the parallel processing units and/or the at least one storage device. A storage device may comprise any number and combination of different memory types. The video processing system may be provided without such hardware, e.g. in the form of software and/or hardware arranged to interact in a suitable way with processing units and/or a storage device or memory. The video processing system may be an encoder and/or decoder. It may be provided in the form of a video codec. The hierarchical enhancement structure may comprise a spatial and/or a temporal and/or a quality enhancement structure.

It may be envisioned that the video processing system is further arranged to update, after the parallel processing unit has processed a task, the task list with information regarding deblocking of the processed task. The task list may be updated with one or more tasks for performing a deblocking of processed video data, in particular of encoded or decoded video data. The video processing system may be arranged to provide or receive a plurality of frames of different resolution of the same image.

A method for parallel processing of video data may be considered. The method may comprise providing input video data to be processed to provide processed video data, the input video data and/or the processed video data having a hierarchical enhancement structure comprising at least one basic layer and one or more enhancement layers dependent on the basic layer and/or at least one of the other enhancement layers. Setting up a task list of video processing tasks with at least one task related to video processing of the basic layer to be processed may be performed. There may be assigned at least one task of the task list to one of a plurality of parallel processing units. Processing of the assigned task by the parallel processing unit may be performed to provide a processed task. It may be considered to update, after processing the assigned task, the task list with information regarding tasks dependent on the processed task and related to at least one enhancement layer. The method may be performed by any of the video processing systems described above. It may be considered that for encoding the processed video data has the hierarchical enhancement structure, such that the encoder provides output data with this structure. For decoding the input video data may have the hierarchical enhancement structure, which may be decoded into display data. The method may loop between assigning at least one of the tasks of the task list and updating the task list until the task list is empty and/or no further tasks related to at least one enhancement layer dependent on a processed task are available. It is feasible that the input video data and/or the processed video data pertain to one access unit. Updating the task list may comprise updating the task list with information regarding deblocking of the processed task. It may be envisioned that the hierarchical enhancement structure comprises a spatial and/or a temporal and/or a quality enhancement structure. The parallel processing units may comprise at least one thread and/or at least one hyper-thread and/or at least one core of a multi-core processor and/or at least one processor. Video processing may be encoding and/or decoding.

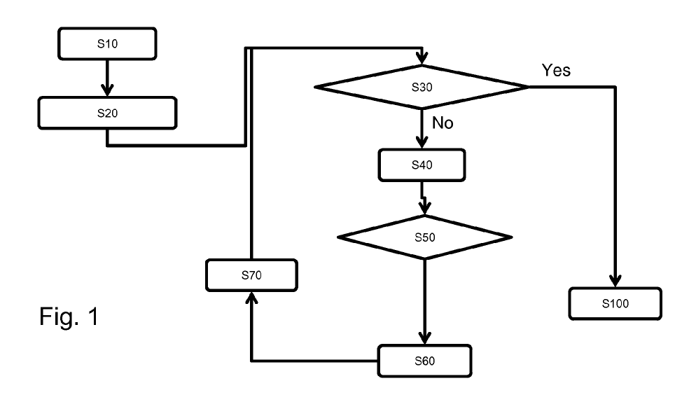

FIG. 1 shows a flow diagram of an exemplary parallelization method for a video encoding process. It may be considered in step S10 to provide a starting frame and/or an access unit to be encoded. In the step S20, a task list, which may be stored in a memory and which may be empty at the beginning of the parallelizing method, may be updated to include a task to encode the starting frame or one or more parts of the starting frame. The starting frame may be a frame of a basic layer of an enhancement structure, in particular of a spatial basic layer. The task of encoding a starting frame may comprise a plurality of independent encoding tasks. In particular, it may be feasible that the starting frame is split into slices to be encoded independently of each other. After updating the task list in step S20, it may be considered to check in a step S30 whether the task list has been emptied and/or the encoding of the present access unit has been finished. If this is the case, it may be branched to a step S100, in which the encoding of the given access unit is finished. If not all video data to be encoded has been processed, it may be returned to step S10 with a new access unit.

If the status check of S30 results in further tasks to be performed inside the given access unit, it may be branched to step S40 in which the tasks may be distributed to a processing unit like a processor, a processor core, a thread or a hyper-thread. There may be provided a master processing unit distributing tasks. It may be feasible that a parallel processing unit accesses the task list itself and takes a task or a portion of a task according to task priority and/or available processing power. In an optional step S50 it may be checked whether any task has been assigned and/or whether the processing units are idle. In the case that no tasks have been assigned, e.g. because the task list is empty, and/or the processing units are idle, it may be branched to one of steps S30 or S100 (branches not shown). Otherwise, the method may continue with step S60.

Following the assignment of one or more tasks to one or more processing units and optionally the check of S50, the tasks may be processed in parallel (step S60). If a given processing unit has finished a task or a portion of a task, e.g. a subtask, it may access the task list and update it accordingly in step S70 following step S60. It is feasible that during updating the task list, new tasks dependent on the finished task are added. For example, it may be considered that after encoding a slice of a spatial basic layer, a task of de-blocking the encoded slice is added to the task list. A task of encoding a corresponding slice of a spatial enhancement layer may be added to the task list. It may be considered that a task of encoding a dependent slice of a temporal layer may be added to the task list. It is possible to add a task of encoding a corresponding slice of a P-frame or B-frame or other frame dependent on the encoded slices added to the task list. There may be provided a function, module, or device arranged to identify dependencies. Dependencies may be identified based on information in the video data and/or requirements of video standards for encoding. From step S70, it may be branched to step S30 in which the status of encoding or the task list is checked. The loop from S30 to S70 may be performed until all tasks directly or indirectly dependent on the starting frame are processed.

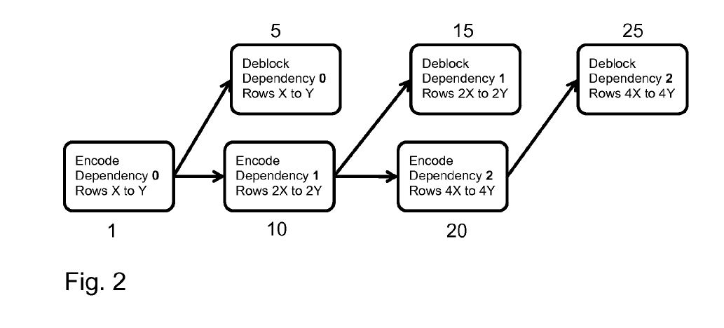

FIG. 2 shows an example of task dependency for a frame for different spatial layers representing information of higher and higher resolution. Block 1 represents a dependency 0, representing, for example, a given number of rows X to Y of a slice of a frame of a spatial basic layer. Only if the corresponding task of encoding the video data of block 1 has been processed, it is possible to deblock the resulting data. Thus, a task 5 of deblocking dependency 0 with rows X to Y may be considered to be dependent on block 1. If dependency 0 has been encoded, the encoding of video information regarding a spatial enhancement layer 10 may be possible as dependency 1. Tasks 5 and 10 may be processed independently of or parallel to each other. The spatial enhancement layer may based on encoded rows X to Y provide information regarding rows 2X to 2Y, doubling the image resolution. Depending on task 10 having been processed, there may be processed a task 15 of deblocking the encoded dependency 1. Independently of deblocking 15, it may be possible to process a task 20 of encoding video data of a second spatial enhancement layer providing higher resolution and being represented by dependency 2. Finishing the task of encoding dependency 2 may provide image information for rows 4X to 4Y. Assuming that no additional spatial enhancement layers are present, finishing task 20 enables as a dependent task 25 the deblocking of encoded dependency 2. The arrows between the blocks show dependencies.

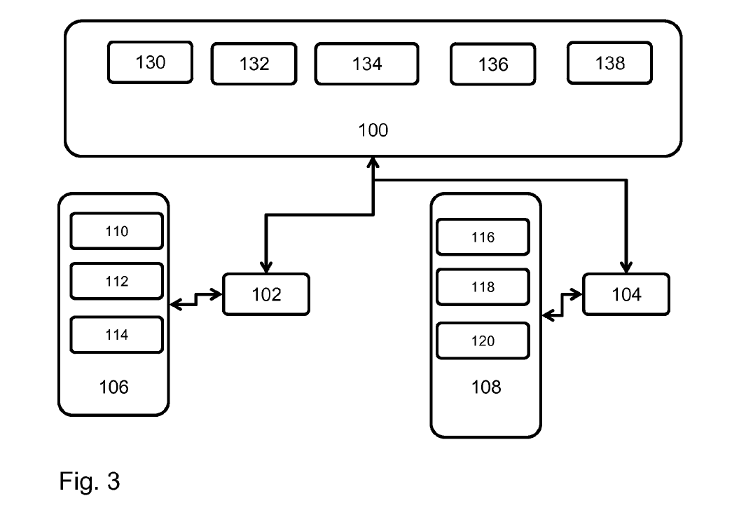

FIG. 3 shows a setup for a video processing system for encoding video data. There may be provided a shared memory 100 which may be accessed by a number of parallel processing units 102, 104. To each parallel processing unit 102, 104 there may be assigned a memory region 106, 108. Each memory region 106, 108 may be a local memory only accessible by the given parallel processing unit. In particular, memory 106 and/or 108 may be directly connected to a core or a processor. Memory 106, 108 may e.g. be cache memory. It may also be feasible that memory 106, 108 is provided in a normal shared memory region, which may be reserved for access by the parallel processing unit or device 102, 104. For each parallel processing unit 102, 104 a different kind of memory may be provided. The memory associated to a processing unit 102, 104 may dependent on whether the processing unit is a thread, a hyper-thread, a core or a processor. It may be considered that different types of processing units are utilized. In particular, processing unit 102 may be of a different type of processing unit than processing unit 104. For example, processing unit 102 may be a core of a multi-core processor, and processing unit 104 may be a thread. It is feasible to provide more than the two parallel processing units 102, 104 shown in FIG. 3.

Memory 106 may store slice data 110 of a slice to be encoded by processing unit 102. It may store related macro-block data 112. Local data 114 used in encoding e.g. counters, local variables, etc. may be stored in memory 106. Memory 108 may comprise data 116 related to a slice to be encoded by processing unit 104, as well as related macro-block data 118 and local data 120.

Video data regarding a source frame 130 may be provided in the shared memory 100. It is feasible to provide more than one source frame. In particular, it is feasible to provide source frames representing the same image at different resolutions. To provide such different source frames, it may be feasible that a single source picture at high resolution is processed to provide lower resolution images. This may be performed externally or by the video processing system. Stored in a region 132 of shared memory 100 there may be a reference frame or reference frames, e.g. several frames regarding different spatial layers already encoded. In region 134 of shared memory 100 corresponding residual frames may be stored. A residual frame may result from combining video processing of source and/or reference frames and may be based on a composition of results of processing tasks. A residual frame may be calculated as difference frame between a source frame and information provided by a corresponding reference frame. A residual frame may comprise information regarding the difference between frames of an enhancement structure, e.g. regarding differences between frames of different spatial layers. The residual frames may be provided by running encoding tasks on the processing units 102, 104. A finished set of residual frames may be considered to be a partial result of the encoding process. Based on the source frames, reference frames and residual frames, a set of reconstructed frames may be provided using processing units 102, 104. Shared memory 100 may store a task list 138, which may be accessible to all the parallel processes or devices 102, 104. The task list may include information regarding tasks which may be performed depending on finished encoding steps. It may be feasible that shared memory 100 comprises information regarding code interaction, for example pointers or counters used when encoding or distributing tasks.

The video processing system and the method described are well-suited for parallelizing scalable video data. In particular, they are suited for use for video processing, in particular encoding/decoding, according to the SVC amendment to the H.264 standard and/or the SVC amendment to the MPEG-4 standard. According to the invention, scalable video processing using enhancement structures or layers can be parallelized. In particular, it is possible to utilize processing units, in particular cores of a multi-core processor, to increase the speed of encoding and/or decoding of video data. Real-time encoding may be achieved depending on the number of cores or processing units utilized. The inventive use of an updated task list causes only limited overhead when parallelizing video processing. Balancing of the load of the processing units is enabled.

The invention may be implemented in a computer program for running on a computer system, at least including code portions for performing steps of a method according to the invention when run on a programmable apparatus, such as a computer system or enabling a programmable apparatus to perform functions of a device or system according to the invention.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on computer readable storage medium or transmitted to the computer system via a computer readable transmission medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM;

ferromagnetic digital memories; MRAM; volatile storage media including registers, buffers or caches, main memory, RAM, etc.; and data transmission media including computer networks, point-to-point telecommunication equipment, and carrier wave transmission media, just to name a few.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

The invention may be implemented using any kind of microprocessor or microprocessor system capable of providing parallel processing units. Whether a microprocessor system provides parallel processing units may depend on software running on it, e.g. an operating system. For example, a Unix-based system or a Gnu/Linux-system may provide threads even if the processor used does not provide advanced parallel-computing facilities. Modern Intel x86 processors or AMD processors with hyper-threading and/or multiple-cores may be utilized. A suitable microprocessor system may comprise more than one processor. The invention may also be implemented on digital signal processors (DSP), which often may provide multiple-.cores. It may also be feasible to implement the invention on a FPGA (field-programmable gate array) system or specialized hardware.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality. For example, a processing unit may be provided with an integrated memory, or it may access a shared memory.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. A video processing system for video processing comprising:
at least two parallel processing units configured to parallel process tasks;
at least one storage device configured to store
input video data to be processed, said input video data comprising a hierarchical enhancement structure comprising at least one basic layer and one or more enhancement layers dependent on one or more of the basic layer and at least one of the other enhancement layers,
processed video data and
a task list of video processing tasks; and
wherein the video processing system is arranged to
assign at least one task of the task list to one of the parallel processing units, and
update, after the parallel processing unit has processed a task, the task list with information regarding tasks related to at least one enhancement layer dependent on the processed task.

2. The video processing system according to claim 1, wherein the parallel processing units comprise one or more of at least one thread and/or at least one hyper-thread and/or at least one core of a multi-core processor and/or at least one processor.

3. The video processing system according to claim 1, wherein the video processing system is one or more of an encoder and/or a decoder.

4. The video processing system according to claim 1, wherein the hierarchical enhancement structure comprises one or more of a spatial and a temporal and a quality enhancement structure.

5. The video processing system according to claim 1, wherein the video processing system is further arranged to update, after the parallel processing unit has processed a task, the task list with information regarding deblocking of the processed task.

6. A method for parallel processing of video data, the method comprising:
providing input video data to be processed to provide processed video data, wherein one or more of the input video data and the processed video data has a hierarchical enhancement structure comprising at least one basic layer and one or more enhancement layers dependent on one or more of the basic layer and at least one of the other enhancement layers;
setting up a task list of video processing tasks with at least one task related to video processing of the basic layer to be processed;
assigning at least one task of the task list to one of a plurality of parallel processing units;
processing the assigned task by the parallel processing unit to provide a processed task,
updating, after processing the assigned task, the task list with information regarding tasks related to at least one enhancement layer dependent on the processed task.

7. The method according to claim 6, wherein the method loops between assigning at least one of the tasks of the task list and updating the task list until one or more of the task list is empty and/or no further tasks related to at least one enhancement layer dependent on a processed task are available.

8. The method according to claim 6, wherein one or more of the input video data and the processed video data pertain to one access unit.

9. The method according to claim 6, wherein updating the task list comprises updating the task list with information regarding deblocking of the processed task.

10. The method according to claim 6, wherein the hierarchical enhancement structure comprises one or more of a spatial and a temporal and a quality enhancement structure.

11. The method according to claim 6, wherein the parallel processing units comprises one or more of at least one thread and at least one hyper-thread and at least one core of a multi-core processor and at least one processor.

12. The method according to claim 6, wherein video processing is one or more of encoding and decoding.
